(19) United States
(12) Patent Application Publication
(10) Pub. No.: US 2026/0175431 A1
(43) Pub. Date: Jun. 25, 2026

(54) ROBOT WITH FORCE CONTROL

(71) Applicant: Brooks Automation US, LLC, Chelmsford, MA (US)

(72) Inventors: Brian Carlisle, Los Altos, CA (US); Clifford Geschke, Crystal Lake, IL (US); Kinping Carl Lee, Sunnyvale, CA (US)

(73) Assignee: Brooks Automation US, LLC, Chelmsford, MA (US)

(21) Appl. No.: 19/535,189

(22) Filed: Feb. 10, 2026

Related U.S. Application Data
(63) Continuation of application No. PCT/US2025/043087, filed on Aug. 22, 2025.
(60) Provisional application No. 63/690,918, filed on Sep. 5, 2024.
(60) Provisional application No. 63/756,876, filed on Feb. 11, 2025.

(51) Int. Cl. B25J 9/16; B25J 13/08

(52) U.S. Cl. CPC B25J 9/1674; B25J 9/1633; B25J 9/1651; B25J 13/085

(57) ABSTRACT

A robot employs low ratio drives for one or more axes of movement, such as three primary axes. An arm assembly include two or more arm links that are each rotatable about respective axes, and low ratio drives may be used for their movement. A controller may control one or more drives to control movement of the robot, e.g., an end effector carried by the robot and may determine external forces in Cartesian coordinates acting on the end effector based on a torque change for a motor of a link drive and without use of force sensor information.

### BACKGROUND

Until recently all industrial robots installed in factories were separated from people by safety barriers and interlocks to prevent the robots from colliding with a human and possibly causing injury. Large robots can carry payloads of hundreds of kilograms and are therefore potentially very dangerous due to the masses involved. However, even small assembly robots, which often operate at high tool speeds of 7-10 meters per second, have enough energy to seriously injure humans though their payloads are typically 3 kg or less.

Recently there has been growing interest in allowing robots to work safely next to people in the same working volume without the need for expensive and cumbersome safety screens. This class of robots is referred to in the industry as “Collaborative Robots.”

In 2016, an ISO standard ISO_TS 15066 2016 “Robots and Robotic Devices—Collaborative Robots,” was published listing safe levels for collision forces that would not cause injury to people. Collision force is determined by the robot's and the payload's kinetic energy, the stopping distance and commanded motor torque. The stopping distance is determined by the kinetic energy, the compliance (stiffness) of the part of the human body that is struck, the compliance of the robot structure that strikes the person, and whether the collision occurs in free space or traps a part of the body against a rigid surface. The safe stopping distance can typically vary from a few millimeters to a few centimeters, depending on these factors. In order to comply with this standard, many robots users have had to dramatically slow down their operating speed if there was any chance the robot could collide with a human.

Various efforts have been made to reduce collision forces by way of sensors. For example, laser zone sensors have been used to detect if a person is entering a specified zone and to subsequently slow down or stop a robot. However, these are quite expensive, typically costing thousands of dollars, and for small robots those costs are difficult to justify when compared to a cheaper safety barrier. Also, even if a collision does not occur, this approach negatively impacts the robot's cycle time and productivity whenever a person works close to the robot, which is the real goal and benefit of collaborative robots.

Touch and force or torque sensors can be added to the robot, but these typically only affect the tool tip or part of the robot and require a collision before the control system can react and attempt to slow the robot. Consequently, to allow for an adequate reaction time, the robot must be operated at a slower, less productive speed virtually all the time. These sensors also add cost, and if relied upon on for safety, they must be made redundant or fail-safe.

Work is ongoing in evaluating capacitive distance sensors to sense a human electrical field from a great enough distance to slow down a robot. This work has not been proven safe as clothing and metal objects can interfere with this type of sensing. Also, like laser zone sensors, the robot and work cell cycle time are adversely affected even if a human is in the vicinity of the robot, but no collision occurs.

### SUMMARY OF INVENTION

In accordance with some embodiments, a robot is provided that may operate in proximity to humans, e.g., the robot may be configured to operate alongside human beings according to ISO_TS 15066 2016 regulations, while achieving higher speeds than other collaborative approaches. In one arrangement, the robot may include one or more degrees of freedom, e.g., the robot may include multiple links or other components that are joined together such that each link can pivot or otherwise move in relation to a respective axis relative to the link or other component to which the link is joined. Movement of links or other robot components relative to at least one of the axes (or degrees of freedom) may be driven by a motor and drive train that has a low drive ratio, e.g., having a ratio of 25:1 or less, such as 1:1 for direct drive arrangements, and/or may be back-drivable (i.e., the rotor of the drive motor may be rotated or otherwise moved by exerting force on the driven robot link or other part). In some cases, employing a drive ratio of less than 10:1 for at least two axes, and particularly for at least three major axes of the robot, may provide particular advantages.

In some embodiments, the robot may have a base that is fixed relative to ground or another structure, and an arm assembly may be movable relative to the base. In some embodiments, the arm assembly may be movable along a vertical direction relative to the base and may be cantilevered relative to the base. The arm assembly may include a first link that is pivotable about a first axis relative to the base, and a second link that is pivotable about a second axis relative to the first link. Movement of the arm assembly, the first link and the second link in relation to their respective axes may be driven by a motor and drive train that has a low drive ratio of 25:1 or less (e.g., 1:1) and/or that is back-drivable. In the case of a drive ratio of 1:1, the drive train may be very simple and include a connection of a motor shaft to the respective part, such as a direct connection of a drive motor shaft to the first link. However, other drive train arrangements are possible that have a drive ratio of 1:1 and yet include multiple components. By employing a low drive ratio of 25:1 or less for two axes or degrees of freedom, the robot may have significantly reduced reflected inertia, and thus reduced effective mass, as compared to robotic structures that employ higher ratio drive trains. This may enable the collaborative robot to operate safely at higher speeds in the presence of humans than would otherwise be possible.

In some embodiments, the three degrees of freedom of the robot that employ low ratio drive trains for movement may be the major or “first” three degrees of freedom of the robot. The “first” three degrees of freedom (or movement axes) in this case are determined as the three degrees of freedom physically or functionally nearest the robot base. These “first” three degrees of freedom may have the greatest impact or influence on the speed and distance of movement of the robot end effector or other end portion of the robot since they are often furthest from the end effector and these degrees of freedom typically provide the greatest torque since they need to accelerate the largest inertias. Thus, providing low ratio drive trains with their reduced reflected inertias for at least some of the “first” three degrees of freedom (or movement axes) may have the greatest influence in terms of reducing potential collision forces. Of course, low ratio drive trains may be used for other degrees of freedom that are “further” from the robot base.

In some embodiments, a robot having low ratio drive trains for one or more degrees of freedom may employ a dynamic feedforward control by which feedforward torques are determined in real time and are combined with, e.g., added to, feedback error torques to generate control signals for the drives for each of the at least three degrees of freedom. As is explained in more detail below, the feedforward torques may be determined to account for acceleration or velocity of a corresponding link or other component, and gravitational or frictional force on the link movement, so that feedback error torques can be reduced. Reducing feedback error torques used to determine drive control signals can significantly reduce impact forces during a collision of the robot with a human or other object, and so the robot may be operated at yet higher speeds. In some embodiments, feedback error torques may be limited as a fraction, e.g., 10 to 25%, of a peak motor torque that a drive train may exert on a link or other robot driven component.

In some embodiments, a robot may include a base with a vertical support extending from the base, and an arm assembly supported by the vertical support that is moveable relative to the vertical support along a vertical axis. In some cases, the arm assembly may be cantilevered from the vertical support and have two or more links that are movable about vertical axes. That is, the two or more links may be movable in a horizontal plane, which may reduce the effect of gravitational forces on the movement of the links. An arm assembly drive may be arranged to move the arm assembly relative to the vertical support along the vertical axis, and the arm assembly drive may include a motor and drive train with a drive ratio of less than 25:1 and/or may be back-drivable. The arm assembly may include a first arm link coupled to the vertical support and arranged to rotate relative to the base about a first axis that is oriented in a vertical direction. The first axis may be co-axial with the vertical axis along which the arm assembly is movable, or may be spaced from, and parallel to, the vertical axis. A first link drive may include a motor and drive train that moves the first arm link relative to the base with a drive ratio of less than 25:1 and/or may be back-drivable. The arm assembly may also include a second arm link coupled to the first arm link and that is arranged to rotate relative to the first arm about a second axis oriented in the vertical direction. As an example, a distal end of the first arm link may be coupled to a proximal end of the second link. A second link drive may include a motor and drive train that moves the second arm link relative to the first arm link with a drive ratio of less than 25:1 and/or may be back-drivable. The relatively low drive ratios and/or back-drive capability of the arm assembly drive, and the first and second link drives may provide the robot with a significantly reduced reflected inertia as compared to robots employing higher drive ratios for these components. A third link may be coupled to the second arm link, e.g., at a distal end of the second arm link, and arranged to rotate or otherwise move relative to the second arm link about a third axis. Movement of the third link may be driven by a motor or other means, and a drive ratio used for the third link may be any suitable ratio, although a low ratio used for other components may be preferable in some arrangements. A controller may provide control signals to the arm assembly drive and to the first and second link drives to move the arm assembly, the first arm link and the second arm link, respectively.

In some embodiments, the vertical support may be arranged to pivot relative to the base about the first axis, and the first link drive may be arranged to pivot the vertical support relative to the base about the first axis, and thereby move the first link relative to the base about the first axis. Thus, the first arm link may be fixed relative to the vertical support with respect to pivotal movement about the first axis, and instead may pivot with the vertical support about the first axis. Although the first arm link may be fixed relative to the vertical support with respect to rotation about the first axis, the first arm link may be moveable relative to the vertical support along the vertical axis, along with the rest of the arm assembly. In another embodiment, the arm assembly includes a carriage that is attached to the vertical support and is arranged to move relative to the vertical support along the vertical axis. The arm assembly drive may be arranged to move the carriage relative to the vertical support along the vertical axis, and the first arm link may be pivotally attached to the carriage and arranged to pivot relative to the carriage about the first axis or an axis parallel to the first axis. Thus, in this arrangement the first link drive may be arranged to move the first arm link relative to the carriage about the first axis or an axis parallel to the first axis, and thereby move the first arm link relative to the base.

The arm assembly drive and the first and second link drives may be arranged in different ways to provide a low drive ratio. For example, the motors of the first and second link drives may be directly connected to the first and second arm links, respectively, to provide a 1:1 drive ratio. In other embodiments, a 1:1 or other low drive ratio may be provided with some sort of transmission between the motor and driven part, such as a belt drive between the drive motor and the respective moved part. In some cases, the first and/or second link drive motor could be located coaxially with the first or second axis (e.g., so a motor rotor rotates about the first or second axis), or could be located more remotely, such as within or otherwise on the vertical support and a drive belt or other transmission may deliver the driving force to the first or second link arm. Providing the drive motor away from the first or second axis may reduce inertia of the first and/or second links by positioning the motor mass closer to, or completely isolated from, a movement axis.

As noted above, a robot having low ratio drive arrangements for one or more degrees of freedom may be controlled using control signals for the drive motors that include feedforward and feedback torque components. In one embodiment, control signals provided by the controller to the arm assembly drive and to the first and second link drives includes a feedforward torque component, e.g., that may be determined in real time and based on acceleration, gravity, velocity and/or friction components regarding the robot part to be moved. The control signals may also include a feedback torque component that may be limited to 10% to 25% of the maximum motor torque for the motor receiving the control signal.

As will be appreciated from the above, in at least some embodiments, the potential collision force of a robot may be reduced by a combination of reducing the forward reflected inertia of the motors and drive train for at least some joints and reducing the motor torques that contribute to the collision force. As described above, forward reflected inertia can be reduced by employing low ratio drives for at least three movement axes. The contributing motor torques may be decreased by computing in real-time the theoretical dynamic feedforward motor torques necessary to drive the robot components, e.g., links associated with at least three degrees of freedom of the robot. The robot controller may differentiate between the feedforward torque components of a control signal and feedback torque components of the control signal, such as proportional-integral-derivative (PID) feedback error torques (e.g., which may include position error torque, integral error torque, derivative error torque, and acceleration error torque), that correct for deviations during normal operation and collisions (also referred to as the feedback). When the feedforward torques are properly determined, the normal operating feedback torques can be a relatively small percentage of the total available or maximum motor torque of motors being controlled, and the feedback torques can be limited to significantly reduce the motor torques generated during a collision. In at least some embodiments, drive control according to this aspect of the invention differs from other techniques in that collision force limiting is effective at all times during robot movement and control and does not require detecting a collision and switching control modes to become effective. Further, as will be explained more below, it is possible to limit the motor torque in a collision to a small percentage of the total available or maximum motor torque, for example to be 25% or less of the maximum motor torque, thus further reducing collision forces. This may avoid, for example, control signals that cause motor current and torque overshoot during a collision.

Another feature of at least some embodiments is that the safe operating speed of a robot can be increased when working in a “Collaborative Mode” where the robot may potentially collide with a person, so that any such collision does not exceed a specified safe collision force. This higher operating speed in and of itself may result in faster work cell cycle times and greater productivity but compares even more favorably to methods that require that the robot be slowed down when a person enters into the working volume of the robot or is in close proximity to any portion of the robot.

In some embodiments, a robot controller uses a feedforward control algorithm that solves a complete dynamic model of the robot in real time (for example in less than 1 millisecond) to continuously compute the motor torques necessary to theoretically drive the robot, or at least to control motor drives associated with three or more degrees of freedom of the robot. This model includes all the coupled torques between axes, including coupled acceleration forces, centripetal acceleration forces, Coriolis forces, gravity forces, friction forces, and actuator non-linearities, and thus incorporates torque components for all of these features as necessary. The accuracy of this model depends on the smoothness and dynamic repeatability of the mechanical device. In theory, if the robot was dynamically perfect and the model was perfect, the robot could be driven by only feedforward with no feedback and would exactly follow the commanded motions. For robots with direct-drive or low ratio drives, as an example, the accuracy of the model can exceed 90% in predicting the torque necessary to drive the complete range of robot motions. However, for robots with high-friction harmonic-drive speed reducers (which inherently have a high drive ratio), a 30% variation in friction of the harmonic-drives from robot to robot reduces the accuracy to about 60% over a sample of robots. Therefore, in addition to reducing forward-reflected motor inertias, there is a significant advantage in at least some embodiments of this invention in using a direct-drive or low ratio drives with both low and repeatable joint friction.

In at least some embodiments, in addition to the feedforward torques, the controller may determine feedback torques to correct for deviations between the dynamic feedforward model and actual movement of the controlled robot parts and include feedback torque components in control signals provided to robot link drives. The controller may determine the feedback torques utilizing an enhanced classical PID structure, which measures position, velocity and acceleration errors and multiplies these errors by gains and combines them with other corrections. The determined feedforward torques, and the feedback torque components may be added together to provide the total motor torque command or control signal.

When employed with low drive ratio actuators and during standard (non-collision) operation, the feedback error torques can be as low as 10% of the total available or maximum motor torque. It is therefore possible to set a low limit on the PID feedback error torques, for example the feedback torque component of a control signal may be limited to be from 10% to 25% of the total available or maximum motor torque, which effectively limits the motor torque contribution during both low speed and high-speed collisions. When this feedback error torque limit is reached, the torque output is limited accordingly, the position error begins to increase, a position tracking error is generated and the robot decelerates quickly to a safe stop with the maximum motor error torque limited to the 10% to 25% of its peak, providing a very large reduction in low-speed or quasi-static collision force.

In some embodiments, a robot may include a base, a first link coupled to the base and arranged to rotate relative to the base about a first rotary axis, a first link drive including a motor and drive train arranged to rotate the first arm link relative to the base about the first rotary axis and having a drive ratio of 1:1, and an end effector coupled to the first link, e.g., to grip and manipulate an object. A controller may be constructed and arranged to provide control signals to the first link drive to move the end effector relative to the base and may be constructed and arranged to determine external forces in Cartesian coordinates acting on the end effector based on a torque spike (or other variation in torque) for the motor of the first link drive and without use of force sensor information. In some cases, the external forces applied to the end effector are applied by one or more objects distinct from the robot and over which the robot has no control. For example, external forces applied to the end effector may be applied by a human collaborator, a workpiece being manipulated or otherwise operated on by the end effector, by objects contacting a workpiece being manipulated by an end effector, and others.

In some cases, the robot can include a second arm link coupled to the first arm link and arranged to rotate relative to the first arm link about a second rotary axis. A second link drive may include a motor and drive train arranged to rotate the second arm link relative to the first arm link about the second rotary axis and have a drive ratio of 1:1. The controller may be constructed and arranged to provide control signals to the second link drive to move the end effector relative to the base. In short, any two or more links may be coupled together as part of the robot and have a corresponding drive to move the link relative to other links and/or the base. The controller may be constructed and arranged to determine external forces in Cartesian coordinates acting on the end effector and/or on an object held by the end effector based on a torque spike (or other variation in torque) for the motor of one or more of the link drives and without use of force sensor information. This can be done using the Jacobian transpose and its inverse to map between robot joint torques and forces and Cartesian torques and forces at the end effector and/or manipulated object.

These and other aspects of the invention will be understood from the following detailed description.

### BRIEF DESCRIPTION OF THE DRAWINGS

FIG. 1 shows a vertically articulated 6-axis robot;

FIG. 2 shows another embodiment of the horizontally articulated 6-axis robot having a first arm link pivotally coupled to a carriage on a vertical support;

FIG. 3 shows yet another embodiment of the horizontally articulated 6-axis robot having a revised third link;

FIG. 4 shows a block diagram of the major elements of a system for determining dynamic feedforward torque control signals;

FIG. 5 shows steps in a control method for a robot arranged as in FIG. 2;

FIG. 6 shows a 4-axis embodiment with 1:1 drive ratios for three rotary axes;

FIG. 7 shows an illustrative robotic system and operating environment;

FIGS. 8a and 8b show a schematic illustrating a placement operation and robot operation in an illustrative embodiment.

### DETAILED DESCRIPTION

It should be understood that aspects of the invention are described herein with reference to certain illustrative embodiments and the figures. The illustrative embodiments described herein are not necessarily intended to show all aspects, but rather are used to describe a few illustrative embodiments. Thus, aspects are not intended to be construed narrowly in view of the illustrative embodiments. In addition, it should be understood that certain features disclosed herein might be used alone or in any suitable combination with other features.

The safe operating speed for a collaborative robot is determined by the kinetic energy of the moving mass (which is equal to ½mv² ), the motor torque applied during the collision, the compliance (stiffness) of the robot and the region of the person where the robot strikes. The moving mass is composed of the robot payload, the robot structure, and an equivalent mass that represents the forward reflected inertias of the motor rotors and high-speed portion of their drive transmissions measured at the robot gripper or other robot portion that may potentially strike a human. The equivalent mass for the forward reflected inertia about an axis is equal to the sum of the inertias of the motor rotors and the high-speed portion of their transmissions each multiplied by the square of their reduction ratios and divided by the square of the distance from the axis of rotation. For robots with high gear reductions, this equivalent mass can be quite large even though the rotor and transmission masses are relatively small.

Collisions of a robot with a human or other object can be separated into high-speed collisions and low-speed, or quasi-static collisions. For high-speed collisions, the forces due to stopping the kinetic energy of the moving robot are dominant. However, the motor torques commanded by the control system to move the robot can also be important, since conventional robot controllers typically command the maximum motor torques when a collision occurs, causing the robot to drive into a person in an attempt to correct the position and speed errors caused by the collision. For low-speed and quasi-static collisions, the forces due to the control system commanding maximum torque from the motors to correct for position and velocity errors are dominant. When a collision occurs, the drive ratios are also a factor in the collision force, because a component of the collision force will be equal to the commanded motor torque times the drive ratio divided by the moment arm. So, for a given collision force, a lower drive ratio employed at movement axes of the robot results in a higher motor reaction force and improves the ability of a controller to detect a collision.

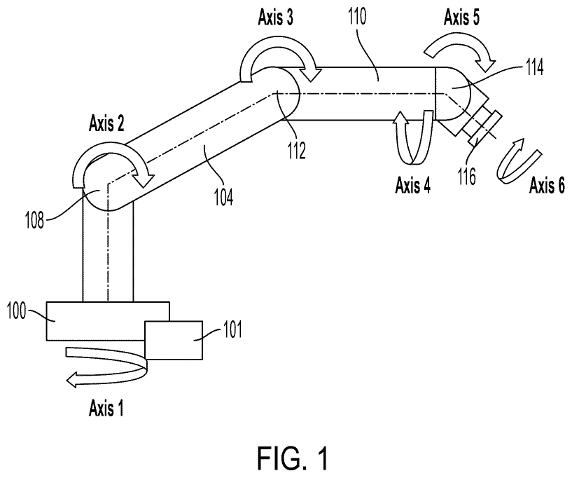

In some embodiments, a robot incorporating one or more features described herein may be configured as a 6-axis robot having the geometric (“kinematic”) structure shown in FIG. 1. However, such an arrangement may result in Axes 2, 3, 4, and 5 being subjected to a large moment arm and torque due to gravity and/or other forces applied on the end effector. For example, a 1Nm motor used with a typical 6-axis rotary link having a length or radius of movement of 1 m can only support 1N. For this reason, 6-axis robots with revolute kinematics like that in FIG. 1 may employ high gear or drive ratios for at least some axes in order to support the high gravity loads while still permitting use of compact motors. However, these high gear ratios also result in very large forward reflected inertias and high kinetic energies and high collision forces, which negatively impact the collaborative nature of these robots.

In accordance with at least some embodiments, the operating speed of a robot can be significantly increased while maintaining safe collision forces with a human by means of a novel combination of mechanical design and control system design. In some arrangements, a control algorithm which dramatically limits motor torques in a collision combined with low drive ratio transmissions for the major axes of the robot and a robot geometry that reduces the required motor drive ratios can allow more than a 100% increase in operating speed for a specified safe collision force when compared to the existing art.

Some embodiments combine a 4, 5 or 6-axis robot geometric structure with low-ratio drives (less than 25:1 drive ratio) or direct-drives (1:1 drive ratio) for the major rotary axes, which dramatically lowers the forward-reflected motor inertias. Such an arrangement can be employed with a control algorithm that limits motor torque in a collision to a small fraction of available motor torque. This combination may reduce both low speed and high-speed collision forces and significantly increases the safe operating speed when there is a possibility it may collide with humans. This higher safe operating speed permits this robot to perform operations at the same or somewhat faster speeds than people while safely working side by side with other personnel, and therefore increases its financial benefit.

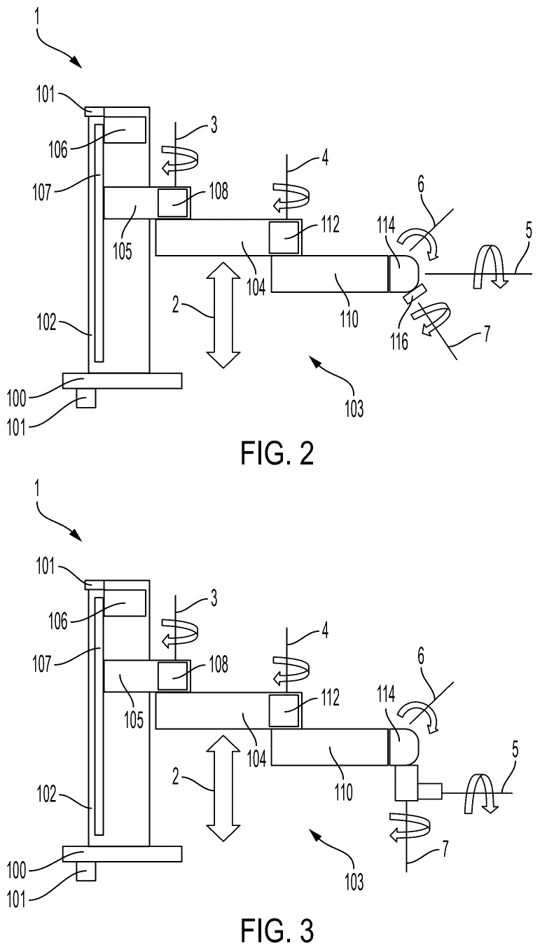

In some embodiments, a robot may be configured generally as shown in FIGS. 1 and/or 2 include a base 100 and a first link 104 coupled to the base and arranged to rotate relative to the base about a first rotary axis (e.g., Axis 3). A first link drive 108 may be provided including a motor and drive train arranged to rotate the first arm link 104 relative to the base 100 about the first rotary axis and may have a low drive ratio of 25:1 to 1:1. One or more other links may be provided, e.g., a second link 110 and second link drive 112 including a motor and drive train arranged to rotate the second arm link 110 relative to the first arm link 104 about a second rotary axis (Axis 4) and may have a low drive ratio of 25:1 to 1:1, a third link 114 having an associated third link drive with motor and low drive ratio, etc. to rotate or otherwise move the third link 114 about one or more axes (Axes 5 and 6, for example). An end effector 116 may be coupled to the first link, e.g., directly or indirectly via one or more links, and may be configured to grip and manipulate an object (e.g., to rotate about one or more axes such as Axis 7, see FIG. 2), apply a tool to a workpiece and/or perform other functions. In some cases, a controller 101 may be constructed and arranged to provide control signals to the first link drive 108 and/or other link drives to move the end effector 116 relative to the base 100, e.g., employing any of the control techniques described herein. The controller 101 may be constructed and arranged to determine external forces in Cartesian coordinates (e.g., in orthogonal X, Y and Z axes) acting on the end effector 116 and/or item carried by the end effector 116 based on a torque increase or other change for the motor of the first link drive 108 (and/or for motors of other link drives) and without use of force sensor information. For example, the controller may be configured to determine such forces acting on the end effector and/or item supported by the end effector without the use of information from a force sensor located on the end effector 116, on the item supported by the end effector, or elsewhere that detects and measures force or pressure applied from an external object. Such a force sensor can convert applied force or pressure to an electrical signal that can be communicated to a controller, but a robot 1 and controller 101 may be configured to determine external forces acting on the end effector 116 and/or item carried by the end effector 116 without the use of information from such a force sensor. For example, the controller 101 may determine forces exerted on the end effector 116 in X, Y and Z axes by a workpiece that interacts with the end effector 116, e.g., as a counterforce in response to a tool operated by the end effector 116 on the workpiece, and may do so without using any force sensor information, e.g., by sensors on the end effector 116, workpiece, tool, link drive or other component. Rather, the controller 101 can use, for example, changes in drive motor current or other indication of torque change at the motor to determine forces acting on the end effector 116 and/or object carried by the end effector 116 in Cartesian coordinates. Thus, the external forces and torques applied to the end effector that are determined may be applied by one or more objects distinct from the robot and over which the robot has no control. This can provide significant advantages since the controller 101 can determine such forces acting on the end effector 116 while avoiding the expense and complexity of force sensors. In some embodiments, the robot 1 may include a force sensor on the end effector 116 and/or item being supported, e.g. as a backup or fail safe for the system to determine the external forces without the use of a force sensor. For example, the primary system for the robot 1 to determine the external forces acting on the end effector 116 and/or item being supported may be the controller 101 using changes in drive motor current or another indication of a torque change at the motor, but the robot 1 may also include a force sensor on the end effector 116 in case the primary system is not functioning. Note that the low drive ratios, e.g., of the type of design in FIG. 2, may provide very little friction between the motors and the links, unlike robots which use high-ratio speed reducers, for example Harmonic Drives, which can have ratios up to 160:1 and have such high friction that motor torques cannot be used to determine forces at the output links. For example, Harmonic Drives typically consume 30% to 40% of motor torque just to overcome friction. Such an arrangement may also provide advantages in controlling movement of the end effector and/or an object carried by the end effector. For example, when inserting an object such as a laparoscopic surgical tool into a relatively close fitting openings such as a trocar, the controller 101 can determine forces and torques exerted on the surgical tool in X, Y and Z directions and control movement of the robot accordingly (e.g., where the Z direction is an insertion direction). Such an application can be challenging because angular misalignment of the surgical tool with the trocar can cause binding or other resistance forces. By determining forces on the surgical tool (and thus the end effector 116) in Cartesian X, Y, Z coordinates, the controller 101 can, for example, arrange any of the axes (e.g., the Z axis) with the proper insertion direction, allowing the controller 101 to identify and react differently to Z-axis forces than to X- and Y-axis forces. Z-axis forces may be expected and well understood, allowing the controller 101 to generally ignore them except when the Z-axis forces exceed a threshold. X- and Y-axis forces and torque about the Z axis may be carefully determined and robot movement controlled to minimize them. This may allow the controller 101, for example, to minimize any binding or other resistance to insertion due to misalignment of the surgical tool with the trocar insertion axis. Another example involves the insertion and/or removal of trays or other items into horizontal storage racks. Such an application may involve the trays or other items binding on portions of the rack during removal and/or placement, and by determining forces and torques on the tray in Cartesian coordinates, the controller 101 can control movement of the robot to eliminate binding. In addition, placement of trays in a rack may involve pushing the tray until it contacts a rear wall of the rack. Here again, the controller 101 can accurately isolate and determine a force on the tray in the insertion direction, and thus accurately determine when the tray has been properly positioned. Accordingly, the controller 101 may be configured to control the robot including the first link drive and/or other link drives to cause the end effector to support an elongated object and move the elongated object with respect to a storage opening, where the elongated object and storage opening are configured to generate a resisting torque or linear force in response to misalignment of the elongated object with the storage opening. This “software remote center compliance” can provide advantages in a variety of different applications. An example is using a robot to hold a tapered pin at an end effector and push the pin into a hole. Where the pin is not centered relative to the hole, the pushing generates a lateral force at the tip of the pin, causing the pin to rotate about its tip and jam instead of sliding into the hole. “Software Remote Center Compliance” is the ability to measure forces and torques at a point distant from the center of the gripper or other end effector, for example at or in front of the tip of the pin, and using this information in software to cause the robot to translate to keep the pin perpendicular to or otherwise suitably aligned with the hole while pushing on the pin, thus causing a successful insertion instead of a failed jam. This force sensing and control technology can also be used for a process called “teach refine”, where a part is inserted into a nest with a certain tolerance, and then the part is pushed back and forth against the walls of the nest using force sensing to detect the walls, and based on the location of the walls, the part is then centered much more accurately in the middle of the nest than can be accomplished by trying to teach the optimal nest location by human vision. This is especially true for nests that are hidden inside equipment. Since the force sensing and robot control can be performed in software, the force measuring and control technique can be flexible and employed with a variety of different robots, end effectors and manipulated objects. Determination of forces and torques acting on the end effector and/or object manipulated by the end effector in Cartesian X, Y and Z directions may be done using a Jacobian transpose matrix that relates the torque at one or more link drive motors (e.g., represented by motor current) to forces along each of the Cartesian X, Y, Z directions and torques about the Cartesian X, Y, Z axes at the end effector or other point such as a location on a gripped and manipulated object. That is, a Jacobian matrix and its inverse can be used to map between joint velocities and Cartesian velocities, and the Jacobian transpose and its inverse can map between robot joint torques and forces and Cartesian torques and forces, e.g., at an end effector or manipulated object. The general Jacobian can be a 6×n matrix where n is the number of robot axes or degrees of freedom. For robots with less axes, such as RPRR and PRRR kinematics, the Jacobian matrix computation may be simplified. In short, a Jacobian matrix can be used to translate the torque at one or more drive motors (e.g., determined based on motor current) to forces and torques on the end effector and/or an object held by the end effector in Cartesian coordinates. This Cartesian force and torque information can be used to adjust and control robot movement, e.g., to avoid binding during object insertion or achieve other purposes.

In some embodiments, one or more robots may work alongside humans and/or other robots as a part of a system to store and/or retrieve items. For example, a robot may retrieve an item from a supply area and place the item in a storage area, such as a bin, drawer, partially enclosed space or other area. In some embodiments, the item may be an elongated object such as a rectangular item and a robot may grasp the elongated object via an end effector, such as a gripper, suction cup, etc., to manipulate and place the item at a storage area.

The inventors have recognized the benefits of a robotic system that can adjust the movement of the robot based at least in part on sensed forces on the end effector when performing a movement, such as placing an item at a storage area. For example, the robot may encounter external forces and/or torques on the end effector and/or elongated object during a placement movement, and the robot may be configured to adjust the movement of the robot and/or elongated object to limit external forces exerted on the object while continuing movement to place the elongated object in the storage area. For example, when placing an object in a bin that contains multiple other objects, the object being placed may contact the other objects in the bin or the bin itself. Such contact may result in forces being exerted on the object and/or robot, and the robot may adjust its movement so forces and torques on the object and/or robot are kept below one or more thresholds in one or more Cartesian directions. Moreover, the robot may perform such adjustment while continuing to move the object into the bin or other storage area when possible. In some embodiments, robot may be configured to move an elongated object held by the end effector with respect to the storage area in a placement direction to position the elongated object at the storage area such that the robot rotates or permits rotation of the elongated object about one or more axes transverse to the placement direction and continues to move the elongated object in the placement direction in response to an external force on the elongated object having a component in the placement direction that is above a threshold. Such rotation and movement along the placement direction may allow the elongated object to move in the placement direction while maintaining the component of the external force in the placement direction on the elongated object to be below the threshold. For example, the robot may be configured to place an item in a space in between other items in the storage area. If the robot senses forces acting on the item held by the end effector in the placement direction that is above a threshold, the controller can control the robot to rotate or permit rotation of the item to allow the item to continue to move along the placement direction while maintaining force exerted on the item to be below the threshold. The external forces may be caused by collision with another item in the storage area, the walls of the storage area, a human, or any other object in the vicinity of the robot. Limiting such force on the item to be below the threshold may, for example, reduce potential damage to the item or other items at the storage area, and/or may allow the item to better align itself with an available space at the storage area. In some embodiments, the rotation of the elongated objected may occur as a controller controls the robot to rotate a portion of the end effector or other robot portion in response to the component of the external force along the placement direction exceeding the threshold. In some embodiments, the controller may control the robot to allow the end effector to passively rotate in response to the external force.

In some embodiments, the robot may move in directions transverse to the placement direction when an external force (or a component of the force) is transverse to the placement direction and exceeds a second threshold, which may be less than or otherwise different from a threshold used for forces along the placement direction. Thus, the controller may be configured to control the robot to move or permit movement of the elongated object in directions transverse to the placement direction in response to the external force having a component that is transverse to the placement direction and exceeds a second threshold. In some embodiments, the robot may be more compliant to external forces in a direction transverse to the placement direction. In some embodiments, the robot may be configured to work alongside humans, and thus be able to adapt to human interaction. For example, if a human contacts the end effector or object held by the end effector and applies a force it in a direction transverse to the placement direction, the robot may be compliant to this force (e.g., move in response to the force) if the force reaches the second threshold. If the second threshold is reached, the controller may control the robot to move in the direction of the external force, or the controller may control the robot allow for passive movement in response to the external force.

In some cases, the controller may control the robot to retract the end effector and item from the storage area if an external force on the item and/or robot exceeds a threshold and adjusted movement of the robot fails to limit the external force to be below the threshold. After retraction, the robot may again attempt to place the item at the storage area by moving the item in the placement direction.

In some embodiments, the robot may be configured to handle and store fragile items such as test tubes, glassware, or other items that may be at risk of breaking due to external forces. If the robot senses external forces above a threshold acting on the item while placing the item in the storage area, the controller may control the robot to rotate and/or reconfigure the item to allow the item to continue to move along the placement direction without external forces above the threshold acting upon it. In some embodiments, the controller may control the robot to retract the end effector and fragile item if the robot senses forces acting on the item that are above the threshold. The robot may then again attempt to place the item at the storage area by moving the item in the placement direction. Limiting such force on the item to be below the threshold may reduce potential damage to the item. In some embodiments, the external force threshold may be set to a lower than normal level for the robot when the robot is handling items that are known to be fragile.

In some embodiments, the controller may be configured to control the robot to move the elongated object in the placement direction with a longest dimension of the elongated object oriented along the placement direction. The controller may be configured to control the robot to cause the end effector to maintain the elongated object at an orientation with the longest dimension of the elongated object oriented along the placement direction even when the external force is exerted on the object that causes the robot to move in an adaptive way to limit force on the object to be below a threshold.

It should be noted that robot described above may not be limited to placing items for storage and retrieval. The present invention may be used in any application involving the placement or other positioning of an object at a storage area. For example, in some embodiments, the robot may be configured to inserting an elongated object, such as a surgical tool, into a narrow opening, such as a trocar or incision.

All the above mentioned operations may be used in conjunction with the Software Remote Center Compliance, as previously discussed, wherein the external force on the end effector or elongated object is determined using a Jacobian transpose matrix that relates the torque at one or more link drive motors (e.g., represented by motor current) to forces along each of the Cartesian X, Y, Z directions. Thus, the forces and torques acting on the end effector and/or elongated object may be determined without the use of force sensors.

In some embodiments that incorporate features described herein, a robot may employ a kinematic configuration incorporating a vertical linear axis like that shown in FIG. 2, which may have advantages over the configuration in FIG. 1. First, the robot portions that pivot about the major rotary axes (the first and second rotational axes 3, 4) move in the horizontal plane, thus eliminating the gravity load on these rotary axes. The gravity load is instead placed on the vertical axis, which can be counterbalanced if desired, and in any case, the moment load on the vertical axis drive is greatly reduced, allowing the use of a much lower drive ratio. For example, a 5:1 or 10:1 drive ratio can be used in the primary gravity loaded axis 2 of the configuration in FIG. 2. This may reduce the reflected drive inertia in the vertical direction. Also, since the major rotary axes move in the horizontal plane and are not gravity loaded, they can be driven by low-ratio or direct-drive transmissions, dramatically reducing collision forces in the horizontal plane due to much lower forward reflected inertias.

At least some embodiments further utilize a dynamic model of the robot for control that provides dynamic feedforward torques (also called feedforward torques herein) to gravity balance and assist in driving the motors of the robot. If robot could be perfectly modeled, the feedforward torques could move the robot's tool tip or other end effector along a specified trajectory without any real-time feedback and with no errors. In practice, dynamic models can be quite accurate but are not perfect. Methods for generating a dynamic model are well known in the art and include empirical as well as mathematical procedures. One such method is described in “Robot Manipulators: Mathematics, Programming, and Control” by Richard P. Paul, 1981, wherein a symbolic model is developed using Lagrangian mechanics. However, in the past, the application of such dynamic models was typically to improve the performance of the robot, such as reducing position tracking errors or achieving greater dynamic stability. In at least some aspects of the invention, a dynamic model of a robot and dynamic feedforward torques are employed, e.g., at all times and all operation modes, to effectively reduce the impact force if a robot collides with a person.

In the illustrative embodiment of FIG. 2, a robot 1 includes a vertical support 102 that is supported by a base 100. The base 100 may be fixed to ground, a floor or other structure, and may be considered stationary in at least some applications. A vertical support 102 is attached to the base 100 and supports an arm assembly 103 that includes a first arm link 104, a second arm link 110 and a third link 114, which may all be cantilevered from the vertical support 102. The arm assembly 103 may be movable relative to the vertical support 102 along a vertical axis 2 and may be moved by an arm assembly drive 106. In this embodiment, the vertical support 102 is depicted as a column or having a cylindrical or rectangular cross section, but the vertical support 102 could have any shape that allows the arm assembly 103 to achieve the desired range of motion along the vertical axis 2. To guide the arm assembly 103 in its motion along the vertical axis 2, the vertical support 102 can include linear and/or rotary bearings, slideways, tracks or another structure to support the arm assembly 103 while providing relatively low friction movement. In this embodiment, the arm assembly drive 106 includes a rotary motor that drives a timing belt 107, chain, cable or other structure to move the arm assembly 103 along the vertical axis, but other drive arrangements could be used instead, such as a linear motor, rack and pinion, ball screw drive, etc. As mentioned above, the weight of the arm assembly 103 could be countered by a moving mass, spring or other element, e.g., to reduce the output force needed for the arm assembly drive 106 to move the arm assembly 103. As an example, the arm assembly 103 could be coupled to a cable that extends over a pulley (e.g., located near the top of the vertical support 102) and to a mass that counters the weight of the arm assembly 103.

In some embodiments, the first arm link 104 is rotatable relative to the base 100 about a first rotary axis 3 that is oriented in a vertical direction. Although other arrangements are possible and are discussed more below, in this embodiment the first arm link 104 is fixed relative to the vertical support 102 with respect to rotational movement about the first axis 3 and is rotated about the first axis 3 by a first link drive 108 that rotates both the vertical support 102 and the first arm link 104 relative to the base 100. A proximal end of the first arm link 104 is attached to the vertical support 102 and extends away from the vertical support 102 to a distal end of the first arm link 104, which is pivotally attached to the second arm link 110. The vertical support 102 may be rotatably supported on the base 100 in any suitable way, such as by a journal bearing, roller bearing, needle bearing, etc. and the first link drive 108 may include any suitable components to move the first arm link 104, such as a rotary motor that directly drives the vertical support 102 or employs a transmission or other drive train.

A proximal end of the second arm link 110 is coupled to the distal end of first arm link 104 and is rotatable relative to the first arm link 104 about a second rotary axis 4 that is spaced from the first axis 3 and is oriented in the vertical direction. Thus, both the first and second arm links 104, 110 are movable in a horizontal plane. The second arm link's 110 rotation is driven by a second link drive 112, which in this embodiment includes a drive motor located within or otherwise attached to the first arm link 104 near the vertical support 102. The motor of the second link drive 112 may be coupled to the second arm link 110 via a drive belt, chain, cable, axle or other transmission element, and may be located proximal to the vertical support 102 inside the first arm link 104. This arrangement may reduce a mass of the arm assembly 103 at or near the second axis 4, and therefore the inertia of the arm assembly 103. In other embodiments, second link drive 112 could instead include a motor that is located co-axially with the second arm link 110's rotational axis, i.e., the second axis 4. For example, a motor of the second link drive 112 could be directly coupled to the second arm link 110 at the joint between the first and second arm links 104, 110 and have a rotor that rotates about the second axis 4. Other arrangements are possible, including having the drive motor mounted to the second arm link 110, but having the motor positioned away from the second axis 4.

A third link 114 is coupled to the distal end of the second arm link 110 and is rotatable relative to the second arm link 110 about a third rotary axis 5. Depending on the embodiment, a 1, 2, or 3-axis version of third link 114 can be attached to the end of the second arm link 110.

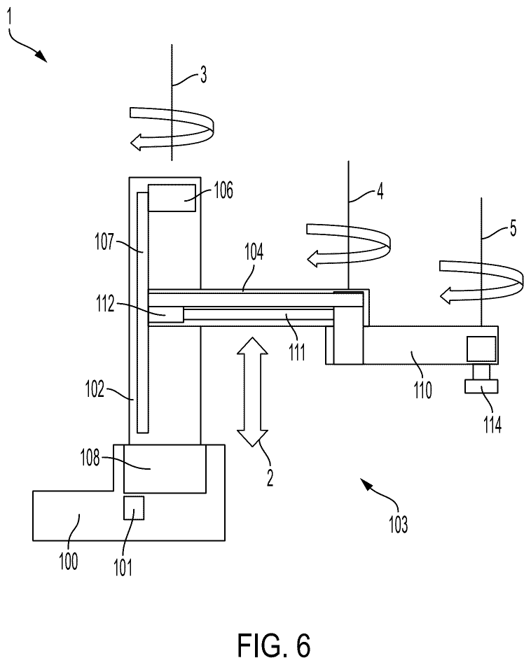

For a 6-axis version of the robot 1, a 3-axis version of the third link 114 may be employed as in FIG. 2. In this embodiment, the third link 114 can rotate about the third axis 5, which is aligned along the length of the second arm link 110 or is parallel to a longitudinal axis of the second arm link 110. Also, the third link 114 may include a component, such as a gripper or other end effector 116, that is rotatable relative to the third link 114 about a fourth rotary axis 6 that in this embodiment is oriented perpendicular to the third axis 5. The component of the third link 114 may also be rotatable about a fifth rotary axis 7, that in this embodiment is oriented in a direction that is perpendicular to the fourth axis 6. In some embodiments, the third, fourth and fifth axes 5, 6, 7 may intersect at a common point. The depicted configuration for the third link 114 is a “Yaw-Pitch-Roll” configuration, in which the Yaw, or third axis 5 allows for rotation about the longitudinal axis of the second arm link 110, the Pitch, or fourth axis 6, allows for rotation about an axis perpendicular to the third axis 5, and the Roll, or fifth axis 7, allows for rotation about an axis perpendicular to the fourth axis 6. Embodiments are not limited to this third link 114 configuration; an alternative is described with a different embodiment below. The overall configuration results in a robot that can articulate in six separate axes. For a 5-axis configuration, the rotary axis about third axis 5 is typically eliminated. For a 4-axis configuration, the rotary axes about both third and fourth axes 5 and 6 are typically eliminated. For example, FIG. 6 shows a robot 1 that is identical to that in FIG. 2, except that the third link 114 or end effector 116 is rotatable only about a third rotary axis 5 that is arranged in the vertical direction. Although other combinations of axis reductions are possible as well.

In some embodiments, each of the arm assembly drive 106, the first link drive 108 and the second link drive 112 include a motor and drive train that have a low drive ratio, i.e., of 25:1 or less, e.g., 10:1 or 1:1. In some cases, the drive train may be very simple, and include a direct connection of a motor rotor to a corresponding link or other driven part of the robot. In other cases, the drive train may include any suitable components, such as belt/chain/cable drives, pulleys, drive axles, bearings, drive gears of any suitable type, etc. The use of low drive ratio drive trains for the “first” three, or major, axes of movement of the robot 1 may provide for relatively high-speed robot movement while complying with collaborative robot regulations and other criteria. Also, the robot 1 may be back-drivable at the joints or movement axes having a low drive ratio (as may also be the case with the FIG. 1 embodiment), e.g., a person may be able to pivot or otherwise move arm links or other robot components by pushing on the components appropriately with low to moderate force, allowing easy teaching of positions by moving the robot by hand. This backdrive capability is simply not present in robots employing high ratio drive transmissions, such as harmonic transmissions and other similar elements. In some cases, a low drive ratio of less than 10:1 may be preferable and may provide advantages over even drive ratios between 10:1 and 25:1.

The robot 1 also includes a controller 101 that provides control signals to the arm assembly drive 106, the first link drive 108, and the second link drive 112 to move the arm assembly 103 and its component parts. Optionally, the controller 101 may provide control signals to control movement of the third link 114 and components of the third link 114, e.g., by providing control signals to one or more motors that drive movement of the third link 114 and its components. In this embodiment, the controller 101 is pictured mounted in the base 100 to further minimize the moving mass of the robot. However, the controller 101 can be mounted externally to the robot or mounted in the links of the robot or distributed throughout the robot without impacting the benefits of this invention. As discussed above, and in more detail below, the controller 101 may determine drive control signals for at least the arm assembly drive 106, the first link drive 108, and the second link drive 112 using a model of the robot 1 that determines dynamic feedforward motor torques and uses those torques to determine appropriate control signals for the drives 106, 108, 112. This may allow for the use of relatively low feedback error motor torques by the controller 101, e.g., that are limited to 10-25% of a maximum motor torque. As also discussed herein, the controller 101 may be configured to determine forces acting on an end effector 116 in Cartesian X, Y and Z directions based on a torque from one or more drive motors, e.g., using a Jacobian.

FIG. 3 shows another embodiment of a robot 1, with a similar arrangement to that of the FIG. 2 embodiment. As above, elements in common with FIGS. 2 and 3 are not described again, and instead only variations in relation to FIG. 2 are discussed. In this embodiment, the third link 114 has a different configuration, but is again capable of rotating in up to three axes. The third link 114 here comprises a “pitch” section that rotates about a third axis 6 that is horizontal and perpendicular to the longitudinal axis of the second arm link 110, a “yaw” section that rotates about a fourth axis 7 that is perpendicular to the third axis 6, and a “roll” section extending outwards from the “yaw” section that can rotate in about a fifth axis 7 and is perpendicular to the “yaw” axis (the fourth axis 7). In this embodiment, the third axis 6 intersects with the fourth axis 7 and the fourth axis 7 also intersects with the fifth axis 5 but at a different point.

As described previously, the configuration of the major axes of motion (the vertical axis, and the first and second rotary axes-2, 3, 4) with the rotations of the first and second arm links in horizontal planes greatly reduce the moment load from gravity on the motors for the first link drive and the second link drive. This makes it possible for low-ratio drives, including direct drive arrangements, to be used in place of higher ratio systems. The low-ratio drive arrangements result in drives that are back-drivable in some embodiments of the robot. The use of low-ratio drive arrangements for the major axes dramatically reduces the forward reflected inertia and thus the effective mass at the gripper/tool tip/other end effector. For example, if the inertia for a 250Nm direct-drive motor arrangement is 0.014 kgm 2 at a one meter radius, with a drive ratio of 1:1, the reflected inertia from the motor has an effective mass of only 14 grams, which is trivial when compared to, for example, a 3 kg payload. In this example, almost all of the kinetic energy will be coming from the payload and the robot structure, not the reflected motor inertia.

In some embodiments, the robot further reduces the impact forces during a potential collision by having the robot controller 101 implement an algorithm designed to limit motor torque during collisions by determining dynamic feedforward torques for at least the major axes (or “first” three axes in the embodiments above of the vertical axis, and the first and second rotary axes) and distinguishing these from the PID feedback error torques to arrive at a final command set or control signal for the relevant drives.

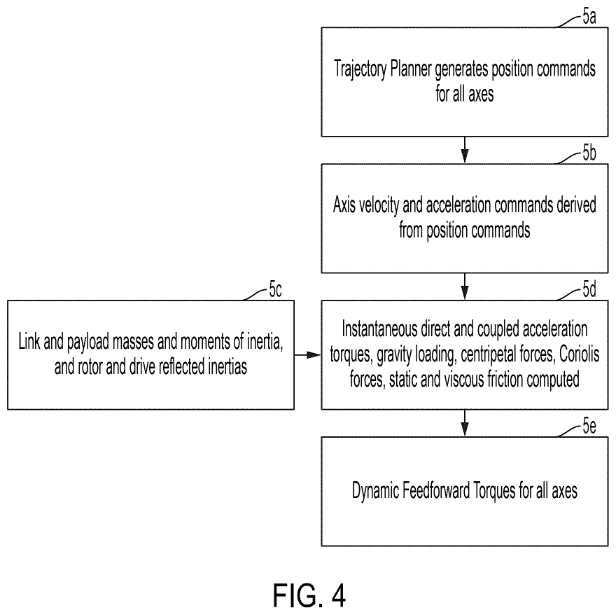

FIG. 4 shows a block diagram that describes how the control circuitry of the controller 101 may determine the dynamic feedforward torques. Each of the components shown in FIG. 4 may be implemented by a suitably programmed computer or other data processor and may be employed in the form of software modules, ASICs, programmable arrays, or any other suitable arrangement. A trajectory planner 5a generates position commands for each axis in real time based on where the robot should be at that moment. That is, the trajectory planner 5a, knowing where the third link 114 or other end effector should be located, determines the positions of the arm assembly 103, the first arm link 104 and the second arm link 110 so that the third link 114 can be properly positioned. In some cases, the “positions for each axis,” i.e., the vertical axis 2, the first axis 3 and the second axis 4, may be the position of the arm assembly 103 relative to the vertical support 102, the position of the first arm link 104 relative to the base 100, and the position of the second arm link 110 relative to the first arm link 104. A variety of well-known techniques can be employed to determine this position information and are not described in detail.

A velocity and acceleration manager 5b uses these position commands to determine the corresponding axis velocity and acceleration commands to achieve the desired position. Again, “axis velocity and acceleration commands” may be the required velocity and acceleration targets for movement of each of the arm assembly 103 relative to the vertical support 102, the first arm link 104 relative to the base 100, and the second arm link 110 relative to the first arm link 104. For pivotal movement, velocity and acceleration may be angular velocity and acceleration, e.g., for the first and second arm links 104, 110. Again, well-known techniques can be used to determine velocity and acceleration control signals for the arm assembly drive 106, the first link drive 108 and the second link drive 112, and are not described in detail herein. Additionally, for the purposes of this invention, the functions of 5a and 5b need not be separated and can be computed at once by the Trajectory Planner 5a if desired.

The position, velocity and acceleration control signals are then combined with the reflected inertia and effective mass modeler 5c information that includes the known link and payload masses for the robot 1, along with the known motor and drive train forward reflected inertias. In one embodiment, this combination process utilizes one or more higher order equations that provide a dynamic model of the robot 1 that accounts for target positions, velocities and acceleration for all of the major axes of motion, as well as the reflected inertia of the drive train and driven components.

Next, a feedforward torque manager 5d combines the position, velocity, and acceleration control signals with the dynamic parameters of the robot generated by the reflected inertia and effective mass modeler 5c to determine motor torques for all of the arm assembly drive 106, the first link drive 108 and the second link drive 112. These torques are determined in real time and can include but are not limited to: the effects of the acceleration of each axis including the direct effect on the axis being accelerated, coupled effects that axes have on other axes, centripetal effects, and gravity loading; Coriolis forces; and static and viscous friction. The inertias considered in the torque calculations include the mass of each link, the mass of the payload, and the forward reflected inertia of the motor rotors and the motor drives and their associated moments of inertia. In one embodiment, the combination process makes use of one or more higher order equations that encapsulates the dynamic model of the robot. In other embodiments, the dynamic model of the robot used by the feedforward torque manager 5d can be implemented by other means including table look up methods and state-space approaches that may at times combine the operations of the reflected inertia and effective mass modeler 5c with the operation of the feedforward torque manager 5d into a single function. The control output manager 5e may use the motor torques to determine motor control signals that are provided by the controller 101. As discussed above, the controller 101 may combine motor torques generated using the feedforward dynamic modeling with feedback torques that are separately determined, e.g., using conventional feedback control techniques. Additionally, while one embodiment generates the feedforward torques for the primary axes (the arm assembly drive 106, the first link drive 108 and the second link drive 112) since they provide the most benefit for a collaborative robot, these same methods can be extended to all axes of the robot if desired.

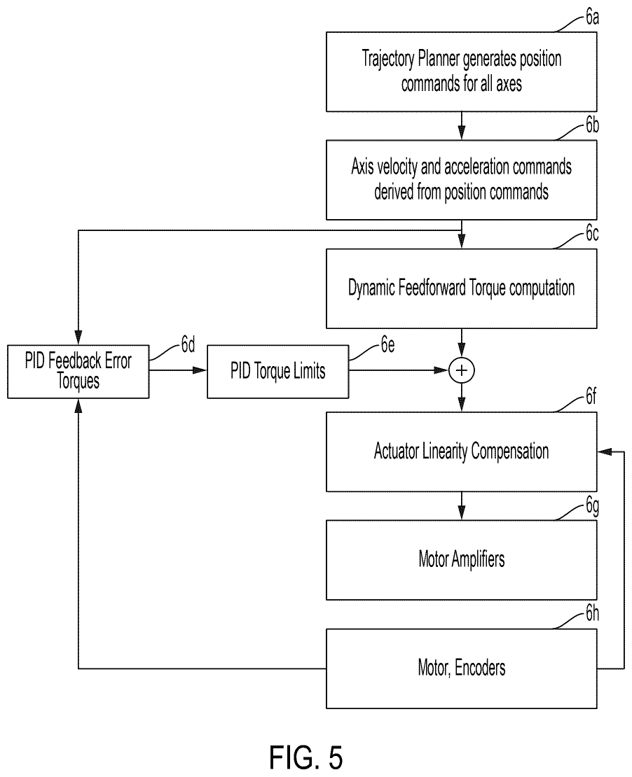

FIG. 5 shows a block diagram describing the controller 101 operations with respect to determining motor control signals. In step 6a, the Trajectory Planner 5a generates the position commands for each axis at a regular rate, such as every few milliseconds. In step 6b, the position commands are used by the velocity and acceleration manager 5b to determine the corresponding axis velocity and acceleration commands. As previously stated, the operations of steps 6a and 6b can be combined if desired and will yield the same functional design. In step 6c, the velocity and acceleration commands are provided for use in the dynamic feedforward torque computation by the reflected inertia and effective mass modeler 5c and the feedforward torque manager 5d. In addition, the velocity and acceleration commands are provided to a PID feedback error torque manager at step 6d. The PID feedback error torque manager is also provided with the actual instantaneous axis positions in step 6h, e.g., by reading encoders or other position indicators for each of the axes. The PID feedback error torque manager compares these position values to the commands to generate correction feedback torques for each motor and provides these correction feedback torques in step 6e to a PID torque limiter, which may limit the correction feedback torques to 10% to 25% of maximum motor torque. This serves to prevent excessive torque delivery in the event of a collision, which tends to produce excessive error signals.

The limited PID feedback torques, and the dynamic feedforward torques are then summed to produce the desired commanded motor torques. However, in some motors, especially direct-drive motors, there can be significant non-linearities between the commanded torque and the actual torque produced by the motor due to errors in the shapes of the motor magnets. To correct for this, an actuator linear compensation manager in step 6f may adjust the commanded motor torques, e.g., to compensate the torque command based upon a motor's position and speed before the commanded torques are sent to the motor amplifiers in step 6g.

In some embodiments, the mechanical system employs either direct-drive or low ratio drives, allowing the accuracy of the dynamic feedforward torques to exceed 90% when predicting the torques necessary to drive the complete range of robot motions. Consequently, the output of the PID feedback error torque manager in step 6e is expected to be quite low, and thus can be limited to a small fraction of total power of the motors without affecting normal operations. This limit further contributes to the reduction of the impact forces during a collision and permits the safe operating speed of this invention to be increased. This allows the robot to comply with ISO_TS 15066 2016 regulations while operating at higher speeds than common in the current art. In addition, the controller 101 can monitor the limiting function and use the information to reliably and quickly determine if a collision has occurred. A collision will be directly indicated by the limit function if the limit is ever reached or if the limit is reached for a period of time. Additionally, by limiting the PID feedback error torques, whose job it is to correct for deviations in the motion of the robot, when a collision occurs, the limits will reduce the controller's ability to correct for errors during the collision and secondary indirect error conditions such as excessive tracking errors will be triggered more quickly.

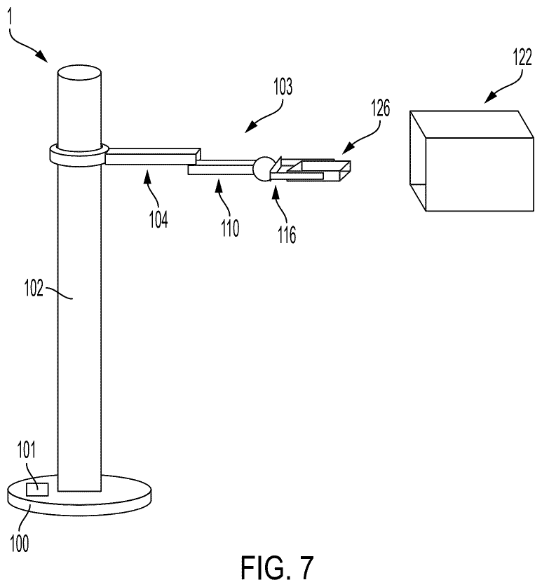

FIG. 7 shows an embodiment including one or more robots 1 working in proximity to a storage area 122. The one or more robots 1 may be configured to handle, store, retrieve, relocate and/or otherwise manipulate items 126 into and out of the storage area 122. The robots 1 may be configured in any suitable way, including, but not limited to those discussed above in FIGS. 1-6. Generally, items 126 to be stored or otherwise manipulated may be provided to a workspace in which the one or more robots 1 operate, and the one or more robots 1 may retrieve the items 126 and place them in one or more storage areas 122. A storage area 122 can be any type of area to receive an item 126, such as a shelf, compartment, cubby, container or other space of any suitable shape and/or size, and storage areas 122 may be differently sized, shaped or otherwise configured, e.g., to accommodate differently sized, shaped, etc., items 126. A storage area 122 may be part of a larger structure, such as a rack, shelving system, frame, etc., and may be enclosed on one or more sides. For example, a storage area 122 may have a rectangular cuboid, cylindrical or other shape that is enclosed and except for a single opening to access the storage area 122. In some cases, such as that in FIG. 7, storage areas 122 may have a rectangular cuboid shape that are open only at a front opening through which items are placed by a robot 1 into the storage area 122.

Items 126 of various sizes, shapes and/or other configurations may be provided to the workspace in any suitable way such as by a conveyor belt, trays, boxes, carts, by hand, etc. The robots 1 may retrieve items 126 and/or containers holding items 126 (such as a tray or box) and place them in a defined storage area 122 so that the items 126 can later be retrieved. For example, the robot 1 may operate to retrieve items 126 from trays and place the items 126 in an appropriate storage area 122. In some cases, the robot 1 may place an entire tray in a storage area 122 and/or may place individual items 126 in a storage area 122. In some embodiments, locations where items 126, trays or other objects that are manipulated by robots 1 (and/or humans working with the robots in the workspace) may be organized vertically, e.g., so that objects are located along a vertical height of 5 feet or more. For example, structures for storage areas 122 may be vertically oriented to hold items in areas near the floor up to a height of 5, 10, 15 feet or more. One or more robots 1 may be configured to operate in such an environment, e.g., a support 102 for the robot 1 configured like that in FIG. 6 may be configured so the arm assembly 103 can be moved along a vertical range of motion of 5, 10, 15 or more feet in height so an end effector 116 can access a lowermost and an uppermost storage area 122. In some embodiments, the base 100 may be mobile relative to a support surface such as the ground, a floor or other structure. In some embodiments, the base 100 may include wheels (not depicted) operatively coupled to a lower surface of the base 100 to permit the base 100 to move along a support surface. The base 100 may rather include tracks, legs, or any other mechanism to allow the robot 1 to travel along a support surface. This mobility may allow the robot 1 to retrieve items 126 and/or containers holding items 126 from more distant areas.

Storage areas 122 may be configured in any suitable way to hold items 126 at the storage area 122. In some cases, the storage area 122 may include a flat floor or lower support surface, include a drawer or other container, include a door, wall or other structure at an opening to the storage area 122 to help prevent items 126 from falling from the storage area 122, etc. In some cases, the robot 1 may be configured to move a drawer, door, wall or other structure used to help hold items at a storage area 122. For example, the robot 1 may move or remove a drawer at a storage area 122 to place an item in the drawer, and then replace the drawer. In some cases, as can be seen in FIG. 7, a storage area 122 may include a retaining device (such as a door, not depicted) disposed across an opening to the storage area 122 to help hold items 126 in the storage area 122.

In some cases, an item 126 may be an elongated object such as a rectangular item, a rod-shaped object, or other item that has one dimension that is longer than other dimensions. To place the item 126 at a storage area 122, the robot 1 may pick up the elongated object 126, e.g., via an end effector 116. As will be understood from the description above regarding the robot arrangements for FIGS. 1-6, the controller 101 may control the various drives and other portions of the robot 1 so the arm assembly is moved to suitable vertical locations and the arm links and/or end effector are moved to manipulate the item 126. To place the item 126 at a storage area 122, the robot 1 may be configured to move the item 126 into the storage area 122 in a placement direction.

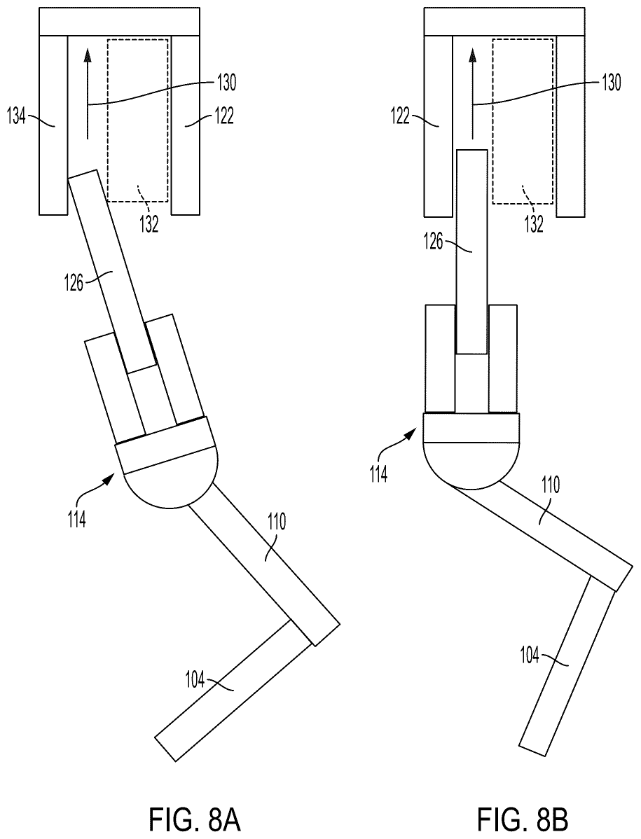

FIGS. 8a and 8b show a schematic top view of a robot 1 placing an item 126 at a storage area 122 and are used to illustrate how a robot 1 can adjust operation in response to encountering forces that exceed one or more thresholds in one or more directions. In FIGS. 8a and 8b, the storage area 122 has an opening (at a lower side in FIG. 8a/8b) and is enclosed by sidewalls (left and right sides in FIG. 8a/8b) and a rear wall (at a top side in FIG. 8a/8b). As in FIG. 7, the storage area 122 may have a lower wall (into the plane of FIG. 8a/8b) and ceiling (out of the plane of FIG. 8a/8b) to enclose the storage area 122. During operation, the robot 1 may move the item 126 in a placement direction 130, which may be generally perpendicular to a plane of the opening to the storage area 122. However, this is not required and the placement direction 130 may be oriented in any suitable way in relation to the storage area 122, including directions with respect to an opening to the storage area 122. When moving the item 126 along the placement direction 130, the robot 1 may encounter one or more external forces that resist placing the item 126 in the storage area 122. For example, an external force may occur from a collision of the item 126 or robot 1 with objects in the storage area 122 and/or in the vicinity of the robot 1 including, but not limited to, the walls of the storage area 122, a human, another robot 1, etc. As previously mentioned, the controller 101 may be configured to determine the external forces acting on the end effector 116 and/or item 126 without the use of information from a force sensor located on the end effector 116, on the item 126 supported by the end effector 116, or elsewhere that detects and measures force or pressure applied from an external object. Such a force sensor can convert applied force or pressure to an electrical signal that can be communicated to a controller, but a robot 1 and controller 101 may be configured to determine external forces acting on the end effector 116 and/or item 126 carried by the end effector 116 without the use of information from a force sensor. For example, the controller 101 may be constructed and arranged to determine the external forces acting on the end effector 116 and/or item 126 carried by the end effector 116 based on a torque increase or other change for the motor of the first link drive 108 (and/or for motors of other link drives), as seen in FIGS. 1 and 2, and without use of force sensor information.

In some embodiments, the robot 1 may include a force sensor on the end effector 116 and/or item 126 being supported, e.g. as a backup or fail safe for the system to determine the external forces without the use of a force sensor. For example, the primary system for the robot 1 to determine the external forces acting on the end effector 116 and/or item 126 being supported may be the controller 101 using changes in drive motor current or another indication of a torque change at the motor, but the robot 1 may also include a force sensor on the end effector 116 and/or item 126 to communicate the external forces to the controller 101 in case the primary system is not functioning.

The robot 1 may be configured to adjust operation in response to an external force, e.g., to limit the external force so as to be below a threshold and allow the item 126 to continue to be moved into the storage area 122 in the placement direction 130. For example, the controller 101 may control the robot 1 to move an item 126 (such as an elongated item) held by the end effector 116 with respect to the storage area 122 in a placement direction 130 to position the elongated object 126 at the storage area 122. If an external force on the item 126 having a component in the placement direction 130 above a threshold is encountered, the robot 1 may rotate or permit rotation of the item 126 about one or more axes transverse to the placement direction and continue to move the item 126 in the placement direction 130. Such rotation and movement along the placement direction 130 may be performed so that the item 126 moves in the placement direction 130 while maintaining the component of the external force in the placement direction 130 on the elongated object 126 and/or robot 1 to be below a threshold. For example, as can be seen in FIG. 8a, a robot 1 may move an item 126 in a placement direction 130 into a space between other items 132 and/or a wall 134 in the storage area 122. If the robot 1 detects an external force acting on the item 126 along the placement direction 130 above a threshold that resists movement of the item 126 into the storage area 122, the robot 1 may rotate or permit rotation of the item 126 as can be seen in FIG. 8b to limit the external force to be below the threshold and allow the item 126 to continue to move along the placement direction 130. In the example of FIG. 8a, the item 126 may bind or otherwise meet resistance between the left wall 134 and object 132 when being moved in the placement direction 130. In response, the robot 1 may rotate or allow rotation of the item 126 (e.g., clockwise as viewed in FIG. 8a) as the item 126 is moved in the placement direction 130 so that the binding force is reduced or eliminated, and the item 126 can be moved further in the placement direction 130. In some embodiments, rotation of the item 126 may occur as the controller 101 controls one or more portions of the robot to rotate and/or may occur passively in response to the external force (e.g., the controller 101 may limit torque of one or more drives to limit the external force on the item 126 so that one or more parts of the robot rotate passively). The adjusted movement of the robot may occur via rotation of the first arm link 104 around a first axis 3 via first link drive 108 and/or the second arm link 110 around a second axis 4 via a second link drive 112, and/or rotation of one or more portions the end effector 116 (see FIGS. 1-4). As noted, such rotation may be passive, e.g., one or more robot portions may rotate relative to other portions in response to the external force, and/or may be caused by one or more drives.

In some embodiments, the controller 101 may be configured to control the robot 1 to move the item 126 in the placement direction 130 with a longest dimension of the item 126 oriented along the placement direction 130. For example, while FIG. 8a shows the robot 1 initially moving the item 126 so that the longest dimension of the item 126 is not oriented along the placement direction 130, the robot 1 may be configured to move the item 126 so its longest dimension is oriented along the placement direction 130 as can be seen in FIG. 8b. This type of movement control may be performed prior to encountering any external force that resists placement of the item 126 at the storage area 122 and may help reduce the likelihood of the item 126 encountering external forces during movement (e.g., because of the smaller frontal area presented during movement). In some cases, the controller 101 may be configured to control the robot 1 to maintain the item 126 at an orientation with the longest dimension of the item 126 oriented along the placement direction 130 even after encountering an external force that exceeds a threshold. For example, the end effector 116 may grasp and rotate a rectangular item 126 so that the longest dimension of the item 126 is oriented along the direction of which the item 126 is inserted in the storage area 122, and such orientation may be maintained, where possible, even when external force exceeding a threshold is encountered.

In some embodiments, an external force may be applied by various objects in at a facility including but not limited to the retaining device at a storage area 122, a human in the workspace, a storage container, another robot, etc. In some cases, an external force may have one or more components that are transverse to a placement direction. This can be seen in FIG. 8a, for example, where the external force exerted by the object 132 and the wall 134 on the item 126 has a component in the placement direction 130 (e.g., downward in FIG. 8a) and at least one component that is transverse to the placement direction 130 (e.g., to the right in FIG. 8a). In some embodiments, a robot 1 may be more compliant or otherwise have a different response to an external force in a direction transverse to the placement direction 130. For example, the controller 101 may be configured to control the robot 1 to move or permit movement of the item 126 in directions transverse to the placement direction 130 in response to an external force having a component that is transverse to the placement direction and exceeds a second threshold. For example, the robot 1 may be configured to work alongside humans, and thus be able to adapt to human interaction. If a human contacts the end effector 116 and/or item 126 and forces it in a direction transverse to the placement direction 130, the robot 1 may be compliant to this force if the force exceeds the second threshold. If the second threshold is reached, the controller 101 may control the robot 1 to move in the direction of the external force component transverse to the placement direction 130, or the controller 101 may control the robot 1 to be passively moved by the external force. In some cases, a second threshold used with forces and components of external forces that are transverse to the placement direction 130 may be less than, the same as or greater than the first threshold used for forces in the placement direction 130. This may allow the robot 1 to provide different responses to different external forces. For example, placing an item 126 at a storage area 122 may be expected to encounter relatively large resistance forces in the placement direction 130 but little or not force in transverse directions. In this case, it may be useful to arrange the second threshold to be less than the first threshold. In some cases, placing an item 126 at a storage area 122 may be expected (or desired) to encounter little or no resistance forces in the placement direction 130 (such as when the item 126 is fragile), but may experience greater force in transverse directions. In this case, it may be useful to arrange the second threshold to be greater than the first threshold, e.g., so the robot tends to move the item 126 along a same trajectory even if the robot is bumped by a nearby human.

In some embodiments, the controller 101 may control the robot 1 to retract an item 126 from a storage area 122 if an external force on the item 126 and/or robot 1 exceeds a threshold and adjusted movement of the robot 1 fails to limit the external force to be below the threshold. After retraction, the robot 1 may again attempt to place the item 126 at the storage area 122, e.g., by moving the item 126 along the placement direction 130 but along a different path than was previously attempted. This arrangement may allow the robot 1 to attempt multiple times to place an item 126 at a storage area 122 even after encountering a resistance force that exceeds a threshold and prevents the item from being placed in previous attempts.

In some embodiments, the robot 1 may be configured to handle and store fragile items 126 such as test tubes, glassware, or other items that may be at risk of breaking due to external forces. If the robot 1 senses external forces above a threshold acting on the item while placing the item 126 in the storage area 122, the controller 101 may control the robot 1 to rotate and/or reconfigure the item to allow the item to continue to move along the placement direction 130 without external forces above the threshold acting upon it. In some embodiments, the controller 101 may control the robot 1 to retract the end effector 116 and fragile item 126 if the robot 1 senses forces acting on the item 126 that are above the threshold. The robot 1 may then again attempt to place the item 126 at the storage area 122 by moving the item 126 in the placement direction 130. Limiting such force on the item 126 to be below the threshold may reduce potential damage to the item 126. In some embodiments, the external force threshold may be set to a lower than normal level for the robot 1 when the robot 1 is handling items 126 that are known to be fragile.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A robot comprising:
a base;
a support extending from the base;
an arm assembly operatively coupled to the support and moveable relative to the support, the arm assembly comprising a first arm link arranged to rotate relative to the base about a first rotary axis and a second arm link coupled to the first arm link and arranged to rotate relative to the first arm link about a second rotary axis;
an arm assembly drive arranged to move the arm assembly relative to the support, the arm assembly drive including an arm assembly motor and drive train arranged to move the arm assembly and having a drive ratio of 25:1 or less;
a first arm link drive including a first motor and drive train arranged to rotate the first arm link relative to the base about the first rotary axis and having a drive ratio of 25:1 or less;
a second arm link drive including a second motor and drive train arranged to rotate the second arm link relative to the first arm link about the second rotary axis and having a drive ratio of 25:1 or less;
an end effector coupled to the arm assembly and configured to hold an elongated object; and
a controller constructed and arranged to provide control signals to the arm assembly drive and the first and second arm link drives to move the end effector relative to the base, the controller constructed and arranged to determine external forces and torques in Cartesian coordinates acting on the end effector or on an elongated object held by the end effector based on a torque increase or other change for the first and second motors of the first and second arm link drives and without use of force sensor information;
wherein the controller is configured to control the robot to move an elongated object held by the end effector with respect to a storage area in a placement direction to position the elongated object at the storage area such that the robot rotates or permits rotation of the elongated object about one or more Cartesian axes transverse to the placement direction and continues to move the elongated object in the placement direction in response to an external force on the elongated object having a component in the placement direction that is above a threshold, such rotation and movement along the placement direction allowing the elongated object to move in the placement direction while maintaining the component of the external force in the placement direction on the elongated object to be below the threshold.

2. The robot of claim 1, wherein the first base is a mobile first base.

3. The robot of claim 1, wherein the arm assembly is movable along the support in a range of motion that is at least five feet high.

4. The robot of claim 1, wherein the arm assembly includes a carriage arranged for movement and driven by the arm assembly drive.

5. The robot of claim 1, wherein the controller is configured to use a transpose of a Jacobian matrix or equivalent to convert the torque increase for the first and second motors to the Cartesian coordinates of the external force and torque.

6. The robot of claim 1, wherein the controller is configured to determine the torque increase of the first and second motors via changes in an electrical current of the first and second motors.

7. The robot of claim 1, wherein the external force and torque applied to the end effector is applied by one or more objects distinct from the robot and over which the robot has no control.

8. The robot of claim 1, further comprising a third link coupled to the second arm link and arranged to rotate relative to the second arm link about a third rotary axis.

9. The robot of claim 7, further comprising a third arm link drive including a third motor and drive train arranged to rotate the third arm link relative to the second arm link about a third rotary axis and having a drive ratio of 25:1 or less.

10. The robot of claim 1, wherein the end effector is a gripper configured to grasp objects of varying shapes and sizes.

11. The robot of claim 1, wherein the first and second arm link drives are configured to limit a resisting torque or linear force in response to the external force when the external force or torque is greater than the threshold.

12. The robot of claim 1, wherein the first arm link drive, second arm link drive, and arm assembly drive are back-drivable.

13. The robot of claim 1, further in combination with a second robot configured to move a retaining device at the storage area.

14. The robot of claim 1, wherein the controller is configured to control the robot to move the elongated object in the placement direction with a longest dimension of the elongated object oriented along the placement direction.

15. The robot of claim 1, wherein the controller is configured to rotate a portion of the end effector or permit a portion of the end effector to rotate in response to the component of the external force or torque along the placement direction exceeding the threshold.

16. The robot of claim 1, wherein the controller is configured to control the robot to cause the end effector to maintain the elongated object at an orientation with a longest dimension of the elongated object oriented along the placement direction.

17. The robot of claim 15, wherein the controller is configured to control the robot to cause or allow the end effector to adjust the orientation of the elongated object in response to the component of the external force along the placement direction exceeding the threshold.

18. The robot of claim 1, wherein the controller is configured to control the robot to move or permit movement of the elongated object in directions transverse to the placement direction in response to the external force having a component that is transverse to the placement direction and exceeds a second threshold.

19. The robot of claim 1, wherein the controller is configured to determine external forces and torques in Cartesian coordinates acting on the end effector or on an elongated object held by the end effector without the use of force sensor information from a force sensor located on or at the end effector and/or elongated object.

20. The robot of claim 1, further comprising a force sensor configured to determine one or more forces acting on the end effector and/or the elongated object.
